(19) United States
(12) Patent Application Publication
(10) Pub. No.: US 2024/0230853 A1
(43) Pub. Date: Jul. 11, 2024

(54) DEVICE AND METHOD FOR SCANNING MEASUREMENT OF THE DISTANCE TO AN OBJECT

(71) Applicant: Scantinel Photonics GmbH, Ulm (DE)

(72) Inventor: Jan HORN, München (DE)

(21) Appl. No.: 18/612,990

(22) Filed: Mar. 21, 2024

Related U.S. Application Data
(63) Continuation of application No. PCT/EP2022/079437, filed on Oct. 21, 2022.

(30) Foreign Application Priority Data
Nov. 23, 2021 (DE) 102021130611.6

(51) Int. Cl. G01S 7/481; G01S 17/32; G01S 17/931

(52) U.S. Cl. CPC G01S 7/4817; G01S 17/32; G01S 17/931

(57) ABSTRACT

A device for scanning measurement of the distance to an object has a light source generating an optical signal that has a varying frequency. The output signal is coupled out of a plurality of optical output waveguides using free-space couplers. A flat plate is tilted by a rotary actuator such that the light beams emerging from the free-space couplers are offset in parallel, wherein said offset increases with increasing tilt angle. A lens deflects the light beams passing the flat plate, and a detector detects a superposition of the optical signal generated by the light source with an optical signal reflected by the object. A distance to the object is computed from the superposition detected by the detector.

### CROSS-REFERENCE TO RELATED APPLICATIONS

This application is a continuation application of International Patent Application No. PCT/EP2022/079437, filed Oct. 21, 2022, which claims the benefit of, and priority to, German patent application No. 10 2021 130 611.6 1, filed Nov. 23, 2021. Each of these applications is incorporated by reference herein in its entirety.

### BACKGROUND OF THE INVENTION

### 1. Field of the Invention

The invention relates to a device and a method for scanning the distance to a moving or stationary object based on FMCW-LiDAR technology. Such devices can be used, for example, in autonomously driving vehicles and often comprise photonic integrated circuits (PIC, Photonic Integrated Circuit) which contain no moving parts.

### 2. Prior Art

A measuring principle known as FMCW-LiDAR is used for optical distance measurement, in which optical signals with a time-varying frequency (FMCW stands for frequency modulated continuous wave) are directed from a measuring device in different directions onto an object to be measured. After reflection at the object, the signals return to the measuring device and are superimposed with a signal that was not emitted and is therefore referred to as a local oscillator. Due to the light path traveled, the reflected signal has a slightly different frequency than the non-radiated signal. When the two signals are superimposed, a comparatively low-frequency beat frequency is produced, which is detected by a detector of the measuring device and used to calculate the distance between the measuring device and the object. If the Doppler shift is also taken into account, the relative speed between the scanner and the object can also be calculated.

Measuring devices based on this measuring principle must be very robust and reliable if they are to be used in vehicles. This is particularly true when the vehicles are driving autonomously, as safety in autonomous driving depends crucially on how reliably a three-dimensional image of the surroundings can be generated with sufficiently high resolution.

For this reason, measuring devices that do not require rotating scanning mirrors or other moving components are preferred, at least for scanning in horizontal planes. In such solutions a distribution matrix with several active or passive splitters arranged like a tree distributes the FMCW signals to different free-space couplers. A deflection optic, in whose focal plane the free-space couplers are arranged, collimates the optical signals emerging from the free-space couplers and radiates them in different directions.

For achieving the required high spatial resolution in the horizontal plane, a large number of free-space couplers must be arranged in a very confined space. However, this quickly reaches its technological limits. Even if the resolution is achievable, the extremely high integration density leads to a high level of rejects during lithographic production, which has an unfavorable effect on unit costs.

### SUMMARY OF THE INVENTION

The object of the invention is to provide a device and a method for scanning measurement of the distance to an object, with which a high spatial resolution can be achieved at low cost.

In an embodiment, a device for scanning measurement of the distance to an object has a light source configured to generate an optical signal with a varying frequency. The device further comprises a distribution matrix configured to distribute the optical signal to a plurality of output optical waveguides simultaneously. The device further includes a plurality of free space couplers arranged on a common substrate and configured to couple out the optical signals carried in the output waveguides as light beams into the free space. A deflection optics of the device is configured to deflect the optical signals emerging from the optical output waveguides so that they are simultaneously emitted from the device in different directions. A detector detects a superposition of the optical signal generated by the light source with an optical signal reflected by the object. The device also comprises an evaluation unit configured to determine a distance to the object from the superposition detected by the at least one detector. The device further comprises a beam shifting unit which has an actuator for generating a movement and is configured to temporarily displace the light beams emerging from the free-space couplers together—preferably in parallel—before they impinge on the deflection optics.

The disclosure is based on the consideration that in measuring devices based on the FMCW-LiDAR principle, a three-dimensional image of the environment is not obtained instantaneously, but is the result of a scanning process. The three-dimensional image is therefore built up successively, even if several light beams are simultaneously directed at the object at a given time. This successive image formation makes it possible to superimpose a mechanical movement on the scanning process, which leads to a preferably parallel offset of the light beams emerging from the free-space couplers. A displacement of the light beams by a dimension specified by the movement leads to different beam angles behind the deflection optics. As a result, the light beams hit the object at different points before and after the offset. The beam shifting unit can thus be controlled in such a way that points on the object are scanned with a grid density that is twice as high as with a measuring device without a beam shifting unit. Such a doubling of the resolution could otherwise only be achieved with a corresponding increase in the integration density on the photonic integrated circuit or by accepting very high costs.

In one embodiment, the actuator is a translation actuator that is configured to move the substrate with the free-space couplers arranged on it. Moving the substrate changes the relative position of the substrate to the deflection optics, resulting in different beam angles. Alternatively, the deflection optics can be moved. However, this is mechanically more complex, as the deflection optics normally have a higher weight than the photonic integrated circuit with the free-space couplers.

Preferably, the substrate is moved back and forth translationally along a translation direction that runs perpendicular to an exit direction of the light beams The free-space couplers are thus laterally displaced in the focal plane of the deflection optics, whereby the angular spectrum of the emitted light beams changes accordingly. However, the translational movement can also include a component along the exit direction of the light beams, as disclosed in DE 10 2021 111 949 A1. Thus, not only linear, but also circular or elliptical trajectories can be considered for the movement of the substrate.

In principle, it is also conceivable to rotate the substrate. Compared to a translational movement, however, this results in complicated and possibly undesirable angular changes behind the deflection optics.

The movement of the substrate can be intermittent or continuous. An intermittent movement is understood to be a movement in which two or more target positions are approached jerkily and the substrate comes to a brief standstill at the respective target positions.

In order to avoid the high accelerations that occur, it is often more favorable to generate continuous movements with the translation actuator. Harmonic oscillations, which can be tuned to the natural frequency of the substrate, are particularly favorable in this context. In particular, the translation actuator can be configured to set the substrate into an oscillating movement along the direction of translation with a frequency between 20 Hz and 100 Hz. The oscillation frequency should be matched to the scanning frequency at which the light beams scan the object.

The translation actuator may comprise, for example, a moving coil actuator that acts on the substrate. Alternatively, piezoelectric actuators can also be used.

In another embodiment, the beam shifting unit has a flat plate that is transparent to the light beams. The actuator is a rotary actuator that is configured to move the flat plate between at least two angular positions with respect to an axis of rotation that extends at an angle—preferably 90°—to an exit direction of the light beams A flat plate that is tilted in the beam path of the light beams causes a parallel offset of the light beams, which increases with increasing tilt angle. As the light beams only need to be offset laterally by a small amount in order to increase the resolution, the flat plate can be thin. As a result, the mass to be moved in this embodiment can be smaller than in the embodiment explained above, in which the entire photonic integrated circuit is moved.

Preferably, the distribution matrix is a switching matrix with multiple optical switches and is configured to selectively distribute the optical signal to the multiple optical output waveguides. In this way, the optical power generated by the light source can be concentrated on a few simultaneously active optical channels. Preferably, a control device should then be provided which is configured to synchronize the optical switches of the switching matrix with an offset of the light beams caused by the beam shifting unit. The control device thus coordinates the two available degrees of freedom, namely the selection of the free-space couplers activated via the switching matrix on the one hand and the selection of the tilting angle of the flat plate on the other.

However, the distribution matrix can also contain only passive beam splitters so that the optical signal is distributed simultaneously to all optical output waveguides. In this case, it is advantageous if an individually controllable light amplifier is assigned to each output waveguide. This means that individual channels can also be specifically controlled with passive beam splitters.

Preferably, each free-space coupler is configured to couple an optical signal generated by the light source, which has been fed to the free-space coupler from an output waveguide connected to the free-space coupler and has emerged from the free-space coupler, back into the same output waveguide as an optical measurement signal after reflection from the object. Alternatively, however, it is also possible to provide separate free-space couplers for receiving the reflected optical signals, which feed the received optical signals to the detector via separate input waveguides.

Preferably, the free-space couplers are all arranged in a common plane. If scanning is only carried out in one direction, the free-space couplers lie on a straight line.

The light source is usually designed as a laser light source that generates coherent light. This can lead to the formation of speckle patterns on objects with a rough surface, with the result that no light can be received from some scanning points on the surface due to destructive interference.

To avoid such speckle patterns, the beam shifting unit can be configured to superimpose a further movement with smaller amplitudes on the movement. This superimposed movement causes the light beams to move slightly and continuously laterally when they hit the object. While the light beams are directed to other points on the object to increase the resolution, the superimposed movements have such a small amplitude that the light beams essentially remain directed to the same object point, but sweep over it in such a way that no neighboring object point in the scan grid is reached. These small movements, which can follow predefined functions or be (quasi-)random, allow the reflected laser light to interfere constructively, at least temporarily, when it is received by the device.

With regard to the method, the task set out at the beginning is solved by a method for scanning measurement of the distance to an object, the method comprising the following steps:
a) generating an optical signal having a varying frequency;
b) distributing the optical signal to several optical output waveguides;
c) coupling out the optical signals guided in the optical output waveguides as light beams into free space with the aid of free-space couplers, wherein at least one light beam propagates along an exit direction;
d) shifting the light beams emerging from the free-space couplers by guiding the light beams through a transparent flat plate which moves between at least two angular positions with respect to an axis of rotation that extends at an angle to the exit direction of the at least one light beam;
e) deflecting the optical signals emerging from transparent flat plate so that they are emitted in different directions;
f) detecting a superposition of the optical signal generated in step a) with an optical signal which was coupled out in step c) and reflected by the object; and
g) computing the distance to the object from the superposition recorded in step f).

The advantages and preferred embodiments explained above with regard to the device apply accordingly to the method.

### BRIEF DESCRIPTION OF THE DRAWINGS

Further features and advantages of the invention will become apparent from the following description of exemplary embodiments with reference to the drawings, in which:

FIG. 1 is a schematic side view of a vehicle approaching an object detected by a measuring device according to the invention;

FIG. 2 is a top view of the measuring device shown in FIG. 1;

FIG. 3 is a schematic representation of the structure of the measuring device according to an embodiment;

FIG. 4 is a graph in which the frequency of the emitted optical signals is plotted against time;

FIG. 5 shows a switching matrix and the deflection optics of the measuring device shown in FIG. 3;

FIGS. 6a to 6c show a section of the measuring device shown in FIG. 3 in different operating states according to a first embodiment, in which a substrate with free-space couplers is moved in translation;

FIGS. 7a to 7c show a section of the measuring device shown in FIG. 3 in different operating states according to a second embodiment, in which a flat plate is tilted;

FIG. 8 is a schematic representation, based on FIG. 5, of parts of the measuring device according to the second embodiment;

FIG. 9 is a top view of the measuring device shown in FIG. 1, in which the light beams make small movements to avoid speckle patterns; and

FIG. 10 is a graph in which the x-coordinate of the substrate is plotted against time.

### DESCRIPTION OF PREFERRED EMBODIMENTS

### 1. Application Example

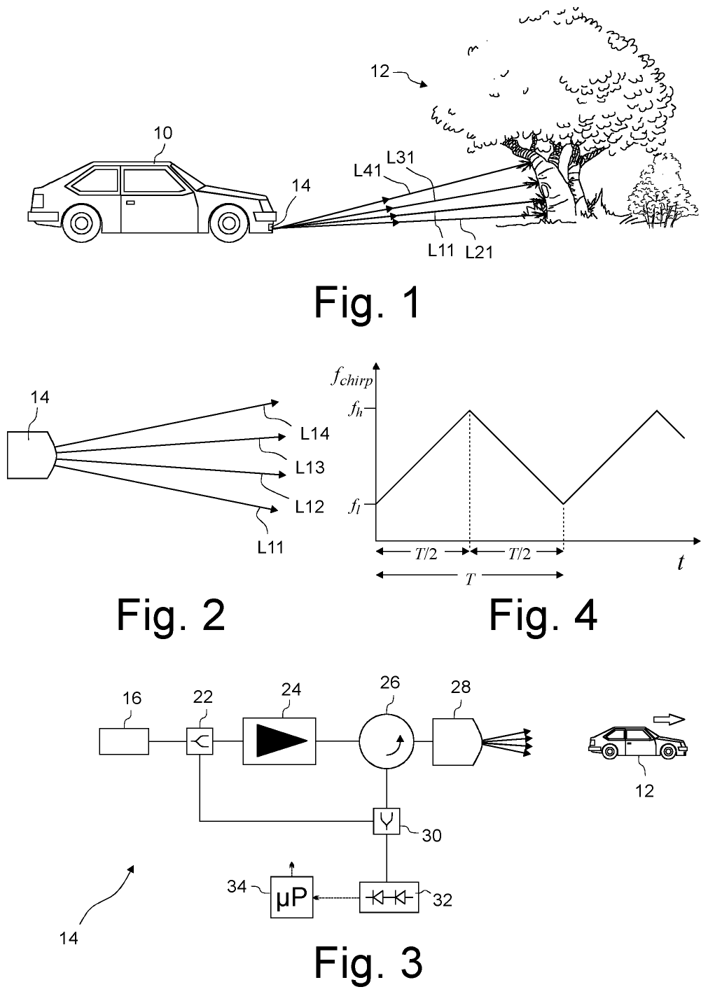

FIG. 1 shows a schematic side view of a vehicle 10 approaching an object 12, which in FIG. 1 is a tree. The vehicle 10 has at least one measuring device 14, which uses light beams L11, L21, L31 and L41 to scan the environment ahead of the vehicle 10 in order to obtain distance values. A three-dimensional image of the surroundings is reconstructed from the distance values. In addition, the measuring device 14 determines the relative speed to the object 12. This information is particularly important if the object 12 is another vehicle or an animal and is also moving.

The information determined by the measuring device 14 about the environment ahead of the vehicle 10 can be used, for example, to assist the driver of the vehicle 10 in controlling the vehicle by generating warning messages when a collision of the vehicle 10 with the object 12 is imminent. If the vehicle 10 is driving autonomously, the information about the environment ahead is required by the control algorithms that control the vehicle 10.

As can be seen in FIG. 1, the measuring device 14 emits the light beams L11 to L41 in different directions in a vertical plane (in FIG. 1 this is the paper plane), whereby the environment is scanned in a vertical direction. At the same time, scanning also takes place in the horizontal direction, as shown in FIG. 2 in a top view of the measuring device 14. Four light beams L11, L12, L13 and L14 are shown there, which are emitted in different directions in a horizontal plane.

For reasons of clarity, it is assumed in FIGS. 1 and 2 that only four light beams Ln1 to Ln4 are generated by the scanning device 14 in four different planes, i.e. a total of 16 light beams. Preferably, the measuring device 14 emits many more light beams. For example, k·2ⁿ light beams are preferred, where n is a natural number between 7 and 13 and indicates how many beams are emitted in one of k planes, where k is a natural number between 1 and 16.

### 2. Measuring Device

FIG. 3 schematically shows the structure of the measuring device 14 according to an embodiment of the invention. The measuring device 14 is designed as a LiDAR system and comprises an FMCW light source 16, which generates measuring light with a varying frequency f_{chirp} during operation of the measuring device 14. As illustrated in FIG. 4, the frequency f_{chirp} varies (“chirps”) periodically over time t between a lower frequency fₗ and a higher frequency fₕ.

Each measurement interval with a chirp duration T is divided into two halves of equal length T/2. During the first interval, the frequency f_{chirp} increases linearly with a constant and positive upchirp rate r, i.e. df/dt=r_{chirp}. During the second interval, the frequency f_{chirp} decreases linearly with a constant negative downchirp rate −r, i.e. df/dt=−r_{chirp}. The frequency of the measured light can therefore be described by a periodic triangular function. However, other functional relationships can also be considered, e.g. sawtooth functions.

As can be seen in FIG. 3, the light source 16 is connected to a splitter 22, which splits the measurement light into reference light (local oscillator) and output light. In the embodiment shown, the output light is amplified in an optical amplifier 24 and then propagates to an optical circulator 26, which directs the amplified measurement light to a deflection unit 28. The optical circulator 26 can, for example, comprise a polarization-sensitive beam splitter which interacts with other polarization-optical elements, as is known in the prior art. Instead of the circulator, for example, a 2×2 coupler can also be used, but this leads to higher light losses.

The deflection unit 28 directs the output light onto the object 12—represented by a moving car in FIG. 3—along different directions, as explained above with reference to FIGS. 1 and 2. Typically, the optical signal emitted by the deflection unit 28 is at least partially diffusely reflected by the object 12. A small part of the reflected signal returns to the measuring device 14, where it is coupled back into the deflection unit 28.

The optical circulator 26 directs the coupled light to a combiner 30, which superimposes the reference light, which was separated from the measuring light by the splitter 22, with the coupled light. Since the frequencies of the superimposed light components differ slightly from one another, a beat signal is produced which is detected by a detector 32, which is preferably designed as a symmetrical photodetector. The electrical signals generated by the detector 32 are fed to a computing unit 34, which calculates the distance R to the object and the relative velocity v between the scanning device 14 and the object 12 from the analysis of beat frequencies.

FIG. 5 shows parts of the deflection unit 28 in a simplified schematic representation. The deflection unit 28 comprises a switching matrix M, in which a plurality of optical switches S11, S21 and S22 are arranged in a tree-like manner With the aid of the optical switching matrix M, optical signals that are received at an input 36 of the switching matrix M can be successively distributed to several output waveguides 38. For reasons of clarity, the optical switching matrix M only has three optical switches in the embodiment shown, so that a total of four output waveguides 38 can be controlled. In real measuring devices 14, eight or more switching levels can be arranged in series so that, for example, 256 output waveguides 38 can be optionally connected to the input 36.

In other embodiments, the switching matrix M is located upstream of the amplifier 24 or between the amplifier 24 and the circulator 26. Alternative embodiments for the integration of switching matrices into the measuring device 14 can be found in EP 3 916 424 A1 and US 2021/0316756 A1.

The output waveguides 38 terminate in free-space couplers 40, with which optical signals guided in the output waveguides 38 can be decoupled into the free space. Such couplers are known in the prior art and can, for example, be designed as grating couplers, which have a widening waveguide area adjoined by a grating structure. Alternatively, the free-space couplers 40 can be edge couplers, which have a higher coupling efficiency than grating couplers.

FIG. 5 shows that the light beams emerging divergently from the free-space couplers 40 are collimated by deflection optics 44 and emitted in different directions. The further a free-space coupler 40 is arranged from an optical axis 42 of the deflection optics, the greater the angle at which the collimated optical signals are emitted by the deflection optics 44.

In the embodiment shown, the deflection unit 28 also serves to receive the optical signals reflected from the object 12 and to couple them back into the output waveguides 38 via the free-space couplers 40. In other embodiments, the reflected signals may be received by separate free-space couplers 40 and fed to the detector 32 via separate waveguides.

### 3. Substrate Movement

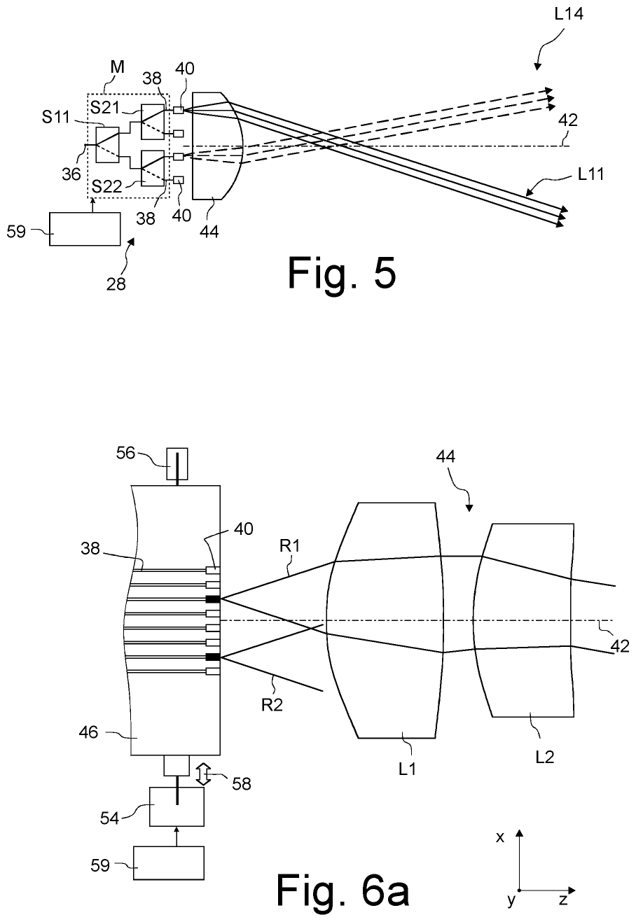

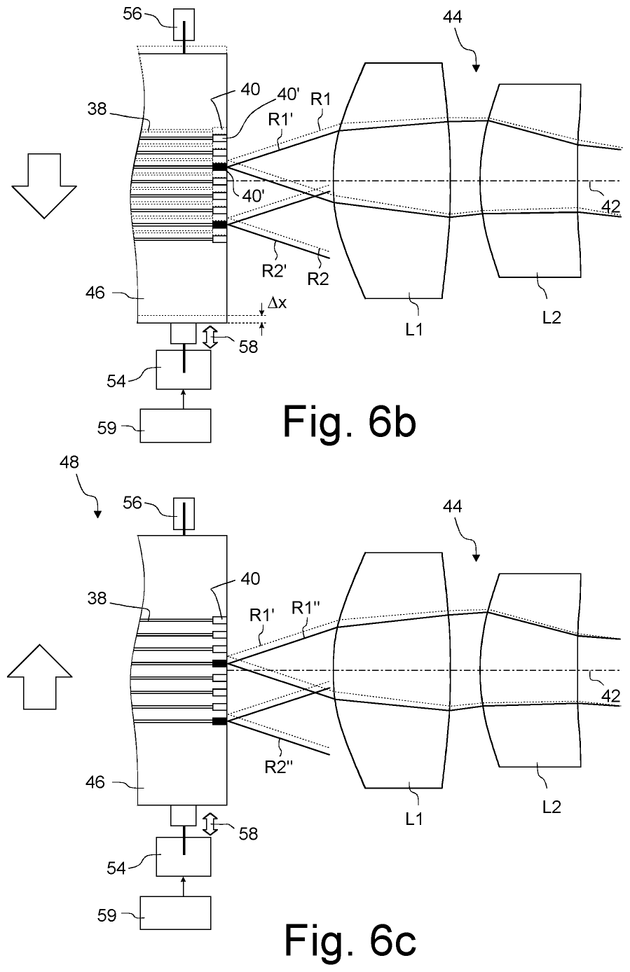

FIG. 6a shows a section of the deflection unit 28 in a schematic representation. A substrate 46 can be seen, which carries eight output waveguides 38, each of which terminates in a free-space coupler 40. The free-space couplers are arranged along a line. In the embodiment shown, the deflection optics 44 comprise two aspherical lenses L1 and L2.

A translation actuator 54 engages laterally on the substrate 46, which can be designed, for example, as a moving coil actuator. The translation actuator 54 interacts with one or more guides 56, which are arranged on the opposite side of the substrate 46. The guides 56 ensure that the substrate 46 can only perform lateral, i.e. perpendicular to the optical axis 42, translational movements. The back and forth movements effected by the translation actuator 54 are indicated by a double arrow 58 in FIG. 6a.

In the switching state of the switching matrix M shown in FIG. 6a, light emerges from two free-space couplers 40, which is indicated by two initially diverging light beams R1, R2. As already mentioned above, the deflection optics 44 collimates the light beams R1, R2 so that they leave the deflection optics 44 parallel but inclined with respect to the optical axis 42.

FIG. 6b shows the arrangement shown in FIG. 6a in the same switching state, but after a lateral displacement of the substrate 46 by an amount Δx, which was caused by the translation actuator 54. The offset Δx corresponds to half the pitch between the free-space couplers 40. As a result of this movement, the light beams R1′, R2′ emerging from the free-space couplers are offset in parallel. In FIG. 6a, the light beams R1, R2 emerging from the free-space couplers before the lateral offset are indicated with dotted lines.

The offset light beams emerge from the deflection optics 44 at a different angle, as can be seen in FIG. 6b on the right. For the light beam R1′, the offset means that it exits closer to the optical axis 42, so that the exit angle from the deflection optics 44 becomes smaller For the light beam R2′, the conditions are reversed (not shown), i.e. the exit angle becomes larger. The lateral offset of the substrate 46 therefore produces two additional exit angles, which cannot be obtained using the switching matrix M alone.

FIG. 6c shows the arrangement shown in FIG. 6b after the substrate has been returned to its initial position shown in FIG. 6a with the aid of the translation actuator 54. This corresponds to a movement by the distance −Δx. However, the switching matrix M is now in the next switching state. As can be seen from a comparison of FIGS. 6a and 6c, in the embodiment shown, the switching matrix M is controlled in such a way that the output waveguides 38 are successively switched through from one side to the opposite side, with every fourth output waveguide 38 always carrying light. The light beams R1″ and R2″ that now emerge have different exit angles than the light beams R1, R2, R1′ and R2′.

The intermediate position shown in FIG. 6b, which is brought about solely by moving the substrate 46, thus creates a virtual additional switching state in which the beams R1′, R2′ appear to be emitted from free-space couplers 40′ arranged between the free-space couplers 40 shown in FIGS. 6a and 6c. In other words, the movement of the substrate 46 perpendicular to the optical axis 42 results in what appears to be twice as many free-space couplers (free-space couplers 40 and free-space couplers 40′) as are actually present. In this way, the resolution of the measuring device 14 is doubled without having to increase the number of output waveguides 38 and free-space couplers 40. The doubling of the resolution is achieved solely by the slight offset by the distance Δx.

In the embodiment shown, the substrate 46 is moved back and forth intermittently, with the switching state of the switching matrix M being changed with every second movement. However, other schemes are also conceivable, since the order in which the light beams are directed onto the object 12 is generally not important. The only decisive factor is whether all points on the object 12 within the scanning grid are scanned within one scanning cycle.

It is therefore also possible, for example, to first switch through the free-space couplers 40 in sequence using the switching matrix M and only then move the substrate 46 using the translation actuator 54. After this offset, all free-space couplers 40 are switched through again, but now the intermediate positions shown in FIG. 6b are approached. Such a switching scheme requires fewer movements of the substrate 46 and is therefore advantageous in many cases.

The translation actuator 54 can also set the substrate 46 into a harmonic oscillation, which is synchronized with the optical switches of the switching matrix M in the desired manner (i.e. depending on the selected switching scheme). The translation actuator 54 and the switching matrix M are preferably connected to a common control device 59 for this purpose.

### 4. Tilted Flat Plate

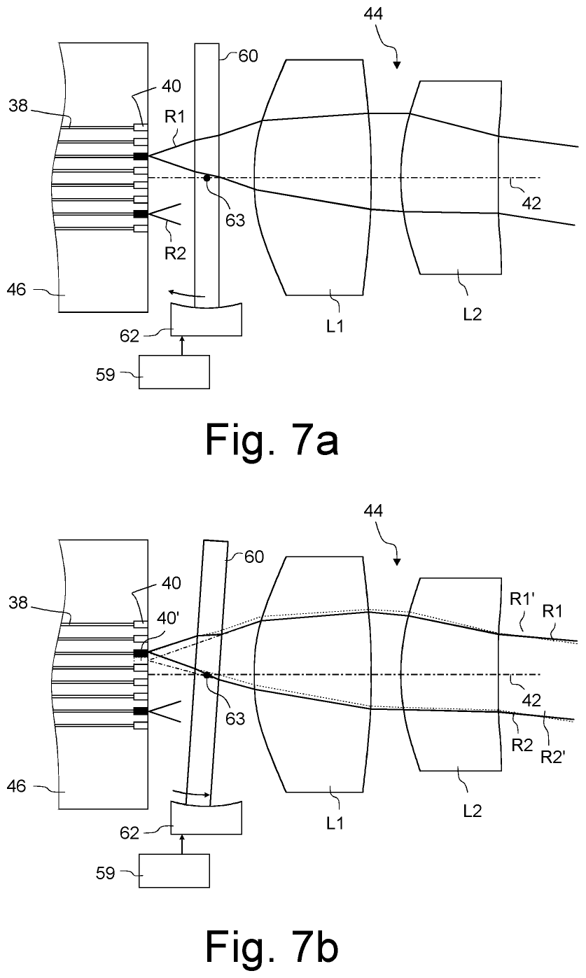

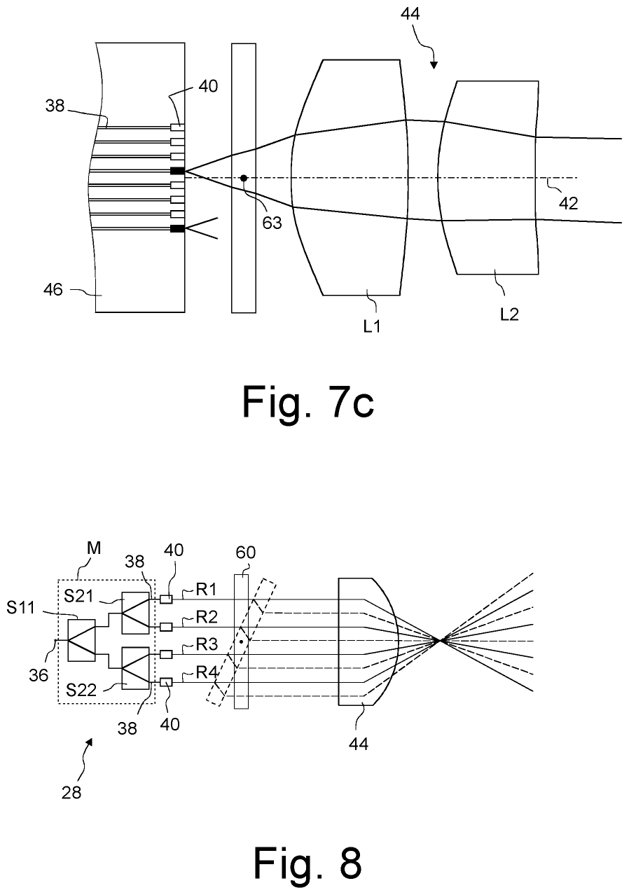

FIGS. 7a, 7b and 7c show, in representations based on FIGS. 6a to 6c, a second embodiment in which a parallel offset of the light beams R1, R2 emerging from the free-space couplers 40 is not caused by a movement of the substrate 46, but by tilting of a flat plate 60 which is transparent to the light beams R1, R2 and is arranged between the substrate 46 and the deflection optics 44. If the deflection optics 44 have an intermediate image plane, the flat plate 60 can also be arranged there.

The flat plate 60 can be tilted about an axis of rotation 63, which extends at an angle of 90° to an exit direction of the light beams R1, R2 and thus parallel to the optical axis 42, by means of a merely schematically indicated rotary actuator 62.

FIG. 7b illustrates how tilting the flat plate 60 by a small angle causes the beams R1′, R2′ to be offset in parallel and thus emerge from the deflection optics 44 at a different angle. The dotted lines show the beam path of the beams R1, R2 for the untilted state as shown in FIG. 7a for comparison. It is clear from the dash-dotted beam path that the beams R1′, R2′ emerging from the tilted flat plate 60 appear to come from a virtual free-space coupler 40′, which is located between two adjacent free-space couplers 40.

The tilting of the flat plate 60 thus achieves essentially the same effect as the lateral offset of the substrate 46 in the first embodiment. Accordingly, different switching schemes are also possible here. In the embodiment according to FIGS. 7a to 7c, the same switching scheme was used as in FIGS. 6a to 6c. The switching state of the switching matrix M thus changes after every second tilting movement of the flat plate 60.

The interaction of the switching matrix M and the flat plate 60 is illustrated again in the schematic FIG. 8. The possible light paths of the emerging light beams R1 to R4 are indicated by solid lines when the flat plate 60 is not tilted. If the flat plate 60 is tilted, the emerging light beams are laterally displaced. In the embodiment shown in FIG. 8, the tilt angle of the flat plate 60 is selected such that the offset is half the lateral distance between the light beams R1 to R4. In this way, the angular resolution behind the deflection optics 44 is doubled so that a uniform angular spectrum is achieved.

### 5. Avoidance of Speckle Patterns

Due to the coherence of the FMCW light source 16, speckle patterns may form on objects with a rough surface. No light can then be received from some scanning points on the surface due to destructive interference.

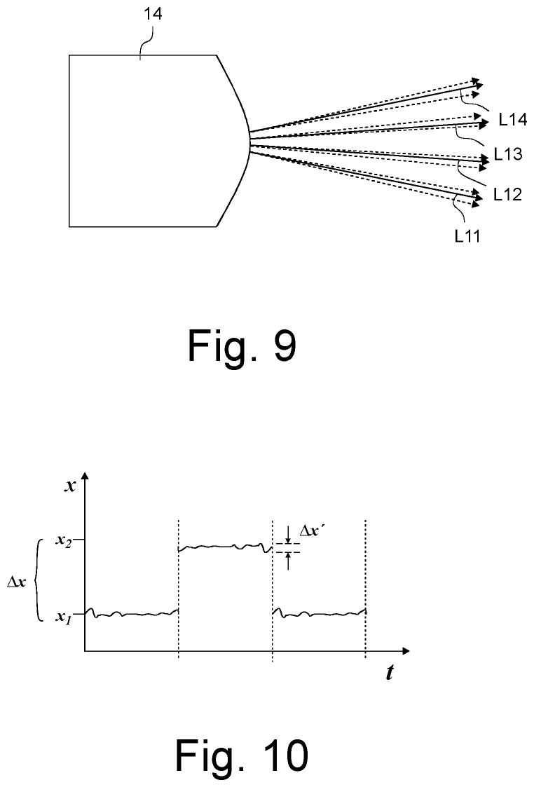

Such speckle patterns can be avoided if the emitted light beams are not directed statically onto the desired scanning points during the measurement, but instead perform small movements so that the illuminated light spots move over the respective scanning point on the surface. FIG. 9 shows this in a representation based on FIG. 2. The light beams L11 to L14 are not stationary, but move over the measuring points of the desired measuring point grid, as indicated by the dashed lines.

Such slightly moving light beams L11 to L14 can be generated if a further movement with a smaller amplitude is superimposed on the movement of the substrate 46 or the flat plate 60 described above. This superimposed movement results in the light beams L11 to L14 moving slightly and continuously laterally when they hit the object 12, as illustrated in FIG. 9.

In the graph of FIG. 10, the x-coordinate of the substrate 46, which is changed by the translation actuator 54 in the embodiment shown in FIGS. 6a to 6c, is plotted as a function of t time. It can be seen that the x-coordinate changes intermittently between the values x₁ and x₂, wherein the offset Δx is given by x₂−x₁. A further movement with a significantly smaller maximum amplitude Δx′ is superimposed on this movement, which serves to avoid speckle patterns. This movement can follow a predefined function or—as indicated in FIG. 10—be (pseudo-)random. Preferably, the relationship |Δx′|≤1/100|Δx|, preferably |Δx′|≤1/1000|Δx|, applies to the amplitude Δx′ of this superimposed movement.

1. A device for scanning measurement of the distance to an object, comprising:
a light source configured to generate an optical signal having a varying frequency,
a distribution matrix configured to distribute the optical signal simultaneously to a plurality of optical output waveguides,
a plurality of free-space couplers that are configured to couple out the optical signals guided in the optical output waveguides as light beams into free space, wherein at least one light beam propagates along an exit direction,
deflection optics configured to deflect the optical signals emerging from the optical output waveguides so that they are simultaneously emitted in different directions from the device,
at least one detector configured to detect a superposition of the optical signal generated by the light source with an optical signal reflected by the object,
an evaluation unit configured to compute a distance to the object from the superposition detected by the at least one detector,
a beam shifting unit configured to temporarily shifting the light beams coupled out from the free-space couplers before they impinge on the deflection optics, wherein the beam shifting unit comprises a flat plate and a rotary actuator configured to move the flat plate between at least two angular positions with respect to an axis of rotation which runs at an angle to the exit direction of the at least one light beam.

1. The device of claim 1, wherein the distribution matrix is a switching matrix comprising a plurality of optical switches, and wherein the distribution matrix is configured to selectively distribute the optical signal to the plurality of optical output waveguides.

2. The device of claim 2, comprising a control unit that is configured to synchronize the optical switches of the switching matrix with an offset of the light beams caused by the beam shifting unit.

3. The device of claim 1, wherein the free-space couplers are arranged in a plane.

4. The device of claim 1, wherein the deflection optics is a collimating optical system having a front focal plane in which the free-space couplers are arranged.

5. The device of claim 1, wherein the axis of rotation forms an angle of 90° to the exit direction of the at least one light beam.

6. The device of claim 1, wherein the axis of rotation is parallel to an optical axis of the deflection optics.

7. The device of claim 1, wherein the deflection optics have an intermediate image plane in which the flat plate is arranged.

8. The device of claim 1, wherein the light beams are shifted by the beam shifting unit by a distance that is half a lateral distance between immediately adjacent light beams.

9. The device of claim 1, wherein the beam shifting unit is configured to superimpose further movements with smaller amplitudes on a movement of the flat plate between the at least two angular positions, thereby avoiding speckle patterns.

10. A device for scanning measurement of the distance to an object, comprising:
a light source configured to generate an optical signal having a varying frequency,
a plurality of optical output waveguides,
a plurality of free-space couplers that are configured to couple out the optical signals guided in the optical output waveguides as light beams into free space,
a flat plate, and
a rotary actuator configured to tilt the flat plate such that the light beams emerging from the free-space couplers are offset in parallel, wherein said offset increases with increasing tilt angle,
a lens configured to deflect the light beams passing the flat plate,
at least one detector configured to detect a superposition of the optical signal generated by the light source with an optical signal reflected by the object, and
an evaluation unit configured to compute a distance to the object from the superposition detected by the at least one detector.

11. The device of claim 11, comprising a plurality of optical switches that are connected to the optical output waveguides and a control unit configured to synchronize the optical switches with an offset of the light beams caused by the flat plate.

12. The device of claim 11, wherein the rotary actuator is configured to tilt the flat plate about an axis of rotation that is parallel to an optical axis of the lens.

13. The device of claim 11, wherein the flat plate is tilted such that the light beams are offset in parallel by a distance that is half a lateral distance between immediately adjacent light beams.

14. A method for scanning measurement of the distance to an object, the method comprising the following steps:
a) generating an optical signal having a varying frequency;
b) distributing the optical signal to several optical output waveguides with a distribution matrix configured to distribute the optical signal simultaneously to a plurality of optical output waveguides;
c) coupling out the optical signals guided in the optical output waveguides as light beams into free space with the aid of free-space couplers, wherein at least one light beam propagates along an exit direction;
d) shifting the light beams emerging from the free-space couplers by guiding the light beams through a transparent flat plate which moves between at least two angular positions with respect to an axis of rotation that extends at an angle to the exit direction of the at least one light beam;
e) deflecting the optical signals emerging from transparent flat plate so that they are emitted in different directions;
f) detecting a superposition of the optical signal generated in step a) with an optical signal which was coupled out in step c) and reflected by the object; and
g) computing the distance to the object from the superposition recorded in step f).

15. The method of claim 15, wherein the distribution matrix is a switching matrix comprising a plurality of optical switches, and wherein the distribution matrix selectively distributes the optical signal to the plurality of optical output waveguides.

16. The method of claim 16, wherein the optical switches of the switching matrix are synchronized with an offset of the light beams caused by the beam shifting unit.

17. The method of claim 15, wherein the light beams are shifted by the beam shifting unit by a distance that is half a lateral distance between immediately adjacent light beams.

18. The method of claim 15, wherein a further movement with smaller amplitudes is superimposed on a movement of the flat plate between the at least two angular positions, thereby avoiding speckle patterns.
